(19) United States
(12) Patent Application Publication
(10) Pub. No.: US 2008/0169738 A1
(43) Pub. Date: Jul. 17, 2008

(54) Side Plate Structure used in a Housing

(75) Inventor: Melwg Li, Xian Tao City (CN)

Correspondence Address: GROSSMAN, TUCKER, PERREAULT & PFLEGER, PLLC, 55 SOUTH COMMERICAL STREET, MANCHESTER, NH, 03101, US

(73) Assignees: DELTA ELECTRONICS POWER (DONGGUAN) CO., LTD., Dong-Guan City (CN); DELTA ELECTRONICS, INC., Taoyuan Hsien (TW)

(21) Appl. No.: 11/863,827

(22) Filed: Sep. 28, 2007

(30) Foreign Application Priority Data
Jan. 16, 2007 (TW) 096101643

(51) Int. Cl. G06F 1/16

(52) U.S. Cl. 312/223.2

(57) ABSTRACT

A housing structure and a side plate structure for use in a housing are disclosed. The housing is adapted to connect to a cover to define a receiving space. The housing comprises a base and two side plates, which are vertically disposed on opposite sides of the base. Each of the side plates comprises an upper folding edge, extending from the upper end of each side plate; and at least one side folding edge, extending from one end of each side plate, wherein the upper folding edge and the side folding edge extend towards the same direction and construct a continuously extension surface.

This application claims priority to Taiwan Patent Application No. 096101643 filed on Jan. 16, 2007, the disclosures of which are incorporated herein by reference in their entirety.

### CROSS-REFERENCES TO RELATED APPLICATIONS

Not applicable.

### BACKGROUND OF THE INVENTION

1. Field of the Invention

The subject invention relates to a housing structure; specifically, it relates to a side plate structure used in electric appliance housing.

2. Descriptions of the Related Art

Housing structures are used in various types of household electric appliances. The housing structure receives and integrates various types of electronic components therein. For example, various types of housing structures are used in personal computers or power supplies.

In computers, the power supplies are mostly cube-shaped and each of them defines a receiving space with a base and cover. Several electronic components, such as transformers, fans and electromagnetic interference (EMI) shielding, etc., can be disposed in the receiving space. Metal plates are generally used to make the base and cover. The base is made by stamping a metal plate to form a box with a bottom and two side plates, and then, fastening the bottom to the plates with screws. Moreover, four engaging holes are arranged on one of the side plates of the base so that the whole power supply can be fastened to the computer cage with screws.

FIGS. 1 and 2 illustrate a housing structure of a prior power supply. The housing structure 10 is formed by stamping a metal plate into a box with a base 11 and two side plates 12. The box is configured for integration with a cover (not shown) to define the receiving space. The side plate attached to the computer cage is called the “functional plate.” The prior technology bends the left, right and upper ends of the two side plates 12 inwardly so that the left and right folding edges 14 and the upper folding edge 13 are formed respectively thereon.

In order to firmly attach the power supply and the computer cage, the engaging holes 30 are respectively arranged on the left and right upper corners and the left and right lower corners of the functional plate. In addition, four screw holes 40 are drilled into the upper folding edge 13. After the transformer, fan, and EMI shielding are disposed in the receiving space, the cover is disposed thereon and several screws are fastened firmly through the screw holes 40. The power supply is then completely assembled. Lastly, the power supply can be securely attached to the computer cage by fastening several screws through the engaging holes 30.

The connecting portions between the upper folding edge 13 and the left and right folding edges 14 have joint lines 50, each at a right angle. After the power supply is attached to the computer cage, the strength of the joint lines may not be enough to support the cage because of the heavy power supply. As a result, the housing structure can be easily deformed. Furthermore, since the two engaging holes 30 located on the left and right upper corners of the side plate 12 are adjacent to the connecting portions of the folding edges 13, 14, the degree of deformation is worsened. When the deformation occurs, impact on the computer cage may cause the power supply to oscillate. In addition, the power may even be short or burnt out. Thus, the quality of the whole product is greatly decreased.

### SUMMARY OF THE INVENTION

An objective of the subject invention is to provide a housing structure which can be securely attached to a main body without any deformation.

According to the subject invention, a housing structure is provided, which can be connected to a cover to define a receiving space. The housing structure comprises a base and two side plates, which are vertically disposed on the two opposite sides of the base. Each of the side plates includes an upper folding edge, extending from the upper end of each side plate; and at least one side folding edge, extending from at least one side end of each side plate, wherein the upper folding edge and the folding edge extend towards the same direction to construct a continuously extension surface.

Another objective of the subject invention is to provide a side plate structure for use in a housing. The side plate structure comprises two side plates, which are vertically disposed on opposite sides of the base. Each of the side plates includes an upper folding edge, extending from the upper end of each side plate; and at least one side folding edge, extending from one side of each side plate, wherein the upper folding edge and the folding edge extend towards the same direction to construct a continuously extension surface.

The detailed technology and preferred embodiments implemented for the subject invention are described in the following paragraphs accompanying the appended figures for people skilled in this field to well appreciate the features of the claimed invention.

### BRIEF DESCRIPTION OF THE DRAWINGS

FIG. 1 is a schematic diagram illustrating the housing structure of the prior art;

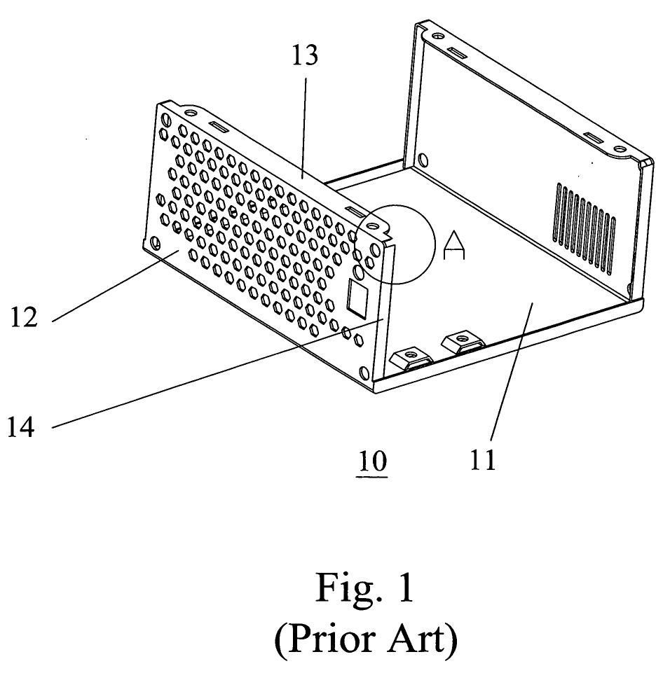

FIG. 2 is an enlarged schematic diagram illustrating the corners of the folding edge of FIG. 1;

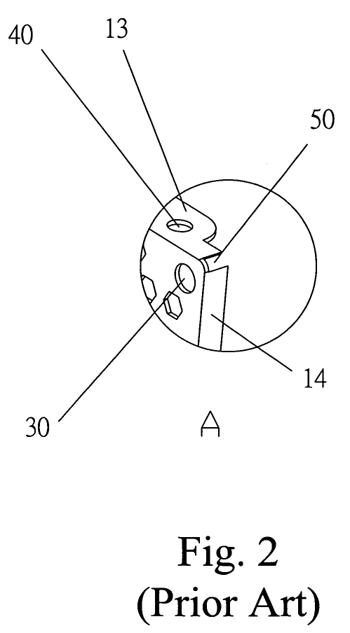

FIG. 3 is a schematic diagram illustrating the housing structure of the subject invention; and

FIG. 4 is an enlarged schematic diagram illustrating the corners of the folding edge of FIG. 3.

### DESCRIPTION OF THE PREFERRED EMBODIMENT

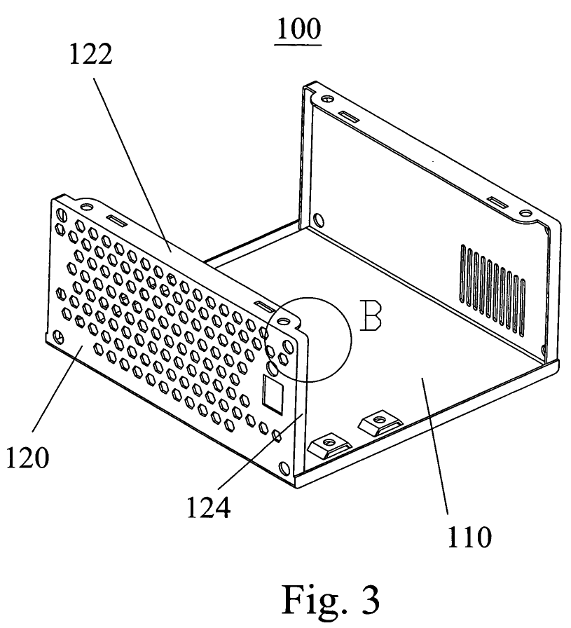

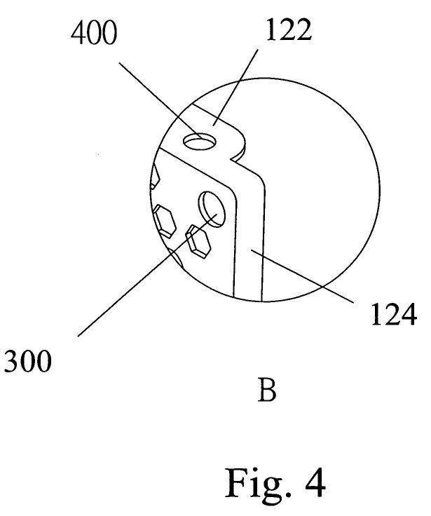

FIGS. 3 and 4 illustrate a housing structure 100 disclosed by the subject invention. The housing structure 100 can be adapted to connect to a cover to define the receiving space for electronic components. Specifically, the housing structure 100 comprises a base 110 and two side plates 120. The side plates 120 are vertically disposed on two opposite sides of the base 110. Each of the side plates 120 includes an upper folding edge 122 extending from the upper end of each side plate 120 and at least one side folding edge 124 extending from one side end of each side plate. More specifically, the upper folding edge 122 and the folding edge 124 extend towards the same direction to construct a continuously extension surface.

In the preferred embodiment, the above-mentioned base 110 and side plates 120 are formed integrally by bending a metal plate. In addition, both the upper folding edge 122 and the side folding edge 124 are formed integrally using the same method to further enhance the strength of the structure thereof. The above-mentioned upper folding edge 122 and the side folding edge 124 both extend towards the receiving space. A continuously curved extension surface is formed between the upper folding edge 122 and the side folding edge 124 around a corner portion of the side plate 120.

For further enhancing the strength of the housing structure, the side plates 120 of the housing structure, as illustrated in FIG. 3, comprise two side folding edges 124 that extend from opposite sides of each side plate. Two continuously extension surfaces between the upper folding edge and the two side folding edges of each side plate 120 are formed accordingly to enhance the strength of the housing structure and suppress the deformation thereof.

Like the prior technology, a plurality of screw holes 400 are disposed on the upper folding edge 122 and one side folding edge 124 of each side plate 120 of the subject invention. The cover can be fastened on the housing structure through the screw holes 400 to form a receiving space for the electronic components. Specifically, a plurality of screw holes are disposed on end portions of the upper folding edge 122 and two side folding edges 124 for receiving fasteners to secure the cover to the housing structure.

Similarly, a plurality of engaging holes 300 can be disposed at proper positions (such as the four corners) on each of the side plates 120 (such as four corners thereof) for receiving fasteners to secure the housing structure to the main body or other structures. For example, when the housing structure of the subject invention is applied to a power supply, the whole power supply can be firmly attached to an electric appliance, such as a computer, through the engaging holes 300.

It is noted that the housing structure of the subject invention comprises a base 110 and two side plates 120 formed integrally; moreover, the housing structure further comprises an upper folding edge 122 and two side folding edges 124 formed integrally. Accordingly, the strength thereof can be enhanced. In addition, the three folding edges are formed integrally without any joint lines therebetween so that the three folding edges of the housing structure are more rigid than that of the housing structure in the prior art. The housing structure can be securely attached to another structure without any substantial deformation. Even if the engaging holes 300 are disposed around the corners of the side plates, no deformation occurs. Furthermore, because the folding edges on the housing structure do not have sharp edges, the maintenance man has a lower risk of injury.

The above examples are only intended to illustrate the principle and efficacy of the subject invention, and not to limit the subject invention. Any people skilled in this field may proceed with modifications and changes to the above examples without departing from the technical principle and spirit of the subject invention. Therefore, the scope of protection of the subject invention is covered in the following claims as appended.

What is claimed is:

1. A housing structure, adapted to connect to a cover to define a receiving space, the housing structure comprising:
a base; and
two side plates, vertically disposed on two opposite sides of the base, respectively, wherein each of the side plates includes:
an upper folding edge, extending from an upper end of each of the side plates; and
at least one side folding edge, extending from at least one side end of each of the side plates, wherein the upper folding edge and the at least one side folding edge extend toward a same direction and construct a continuously extension surface.

2. The housing structure of claim 1, wherein the two side plates and the base are formed integrally, and the upper folding edge and the at least one side folding edge are formed integrally with each of the side plates.

3. The housing structure of claim 1, wherein the upper folding edge and the at least one side folding edge extend toward the receiving space.

4. The housing structure of claim 1, wherein the continuous extending surface is a continuously curved extension surface formed in a corner portion of the side plates.

5. The housing structure of claim 1, wherein the each of the side plates includes two side folding edges, extending from two opposite side edges of each of the side plates.

6. The housing structure of claim 5, wherein the upper folding edge and the two side folding edges of each of the side plates construct two continuously extension surfaces.

7. The housing structure of claim 1, wherein each of the side plates includes a plurality of engaging holes for receiving fasteners to secure the housing structure to a main body.

8. The housing structure of claim 5, wherein the upper folding edge and one of the two side folding edges include a plurality of screw holes, disposed on end portions thereof for receiving fasteners to secure the cover to the housing structure.

9. A side plate structure for use in a housing, comprising:
two side plates, vertically disposed on two opposite sides of the base, wherein each of the side plates includes:
an upper folding edge, extending from an upper end of each of the side plates; and
at least one side folding edge, extending from at least one side end of each of the side plates, wherein the upper folding edge and the at least one side folding edge extend toward a same direction and construct a continuously extension surface.

10. The side plate structure of claim 9, wherein the upper folding edge and the at least one side folding edge are formed integrally with each of the side plates.

11. The side plate structure of claim 9, wherein the upper folding edge and the at least one side folding edge extend toward the receiving space.

12. The side plate structure of claim 9, wherein the continuously extension surface is a continuously curved extension surface formed in a corner portion of the side plates.

13. The side plate structure of claim 9, wherein each of the side plates includes two side folding edges, respectively extending from two opposite side edges of each of the side plates.

14. The side plate structure of claim 13, wherein the upper folding edge and the two side folding edges of each of the side plates construct two continuously extension surfaces.

15. The side plate structure of claim 9, wherein the each of the side plates includes a plurality of engaging holes for fastening the housing structure to a main body.

16. The side plate structure of claim 13, wherein the upper folding edge and one of the two side folding edges include a plurality of screw holes, disposed on end portions thereof for receiving fasteners to secure the cover to the housing structure.
